(19) United States
(12) Patent Application Publication
(10) Pub. No.: US 2009/0065581 A1
(43) Pub. Date: Mar. 12, 2009

(54) Automated System For Verifying Electronic Election Results

(75) Inventors: Jeffrey Augustus Pine, Auburn, NY (US); Mark William Macko, Camillus, NY (US); Qing Gu, Manlius, NY (US); Peter Earl Mott, Baldwinsville, NY (US)

Correspondence Address: BOND, SCHOENECK & KING, PLLC, ONE LINCOLN CENTER, SYRACUSE, NY, 13202-1355, US

(73) Assignee: JADAK, LLC, North Syracuse, NY (US)

(21) Appl. No.: 11/851,463

(22) Filed: Sep. 7, 2007

(51) Int. Cl. G07C 13/00

(52) U.S. Cl. 235/386

(57) ABSTRACT

A reader for automatically reading electronic voting machine paper audit records containing voting information encoded into barcodes printed on the audit records. The reader includes an optical imager for capturing images of barcodes printed on the audit records and a sensor for triggering the capture of images at the appropriate time. The reader further includes a drive mechanism for automatically advancing the audit records and stopping the records at the appropriate location so that the barcodes containing the voting information may be decoded. The reader is programmed to decode and interpret the encoded voting information and then provide the information to a host device. Once receipt of the information by the host has been confirmed, the reader automatically advances the audit record and repeated the decoding process.

### BACKGROUND OF THE INVENTION

1. Field of the Invention

The present invention relates to voting systems and, more particularly, to systems for automatically verifying the results of votes tabulated by electronic voting machines.

2. Description of the Related Art

Electronic voting machines are increasingly being used by various jurisdictions around the country to record and tabulate votes cast by citizens for local, state, and national elections. Due to the transient nature of electronic data, electronic voting machines typically record the votes cast in both electronic and paper form. The electronic and paper records of the votes generally include identifying information pertaining to the particular location as well as specific information about each vote cast, such as the candidate for whom a vote has been made and the position sought by the candidate. With respect to the paper records, information may be printed in text as well as in conventional bar code format on fan fold or roll paper webs.

Many jurisdictions require that the electronic voting records be audited by a separately conducted tabulation of the paper records. This audit process is very cumbersome, however, as it requires the individual tabulation of each vote that is recorded on the paper. Even if the paper web includes bar code information, however, each bar code must be scanned using a handheld bar code scanner, uploaded to a host system, and then manually confirmed to ensure proper receipt of the information by the auditing system. As a result, the process is very labor intensive and still subject to human error. In the event of any mistakes, the electronic voting records cannot be properly confirmed, leading to delays in the voting tabulation process and potential errors in the outcome of the election.

### BRIEF SUMMARY OF THE INVENTION

It is therefore a principal object and advantage of the present invention to provide a system for automatically reading the paper records of electronic voting machines.

It is a further object and advantage of the present invention to provide a system for automatically communicating encoded voting data on paper records to an auditing system.

It is an additional object and advantage of the present invention to provide a system that improves the accuracy of the electronic vote auditing process.

In accordance with the foregoing objects and advantages, the present invention provides an automated reader for reading and processing information encoded onto the paper records generated by electronic voting machines. The reader of the present invention comprises a housing including an optical imager for capturing images of the information encoded onto a paper web by an electronic voting machine. The reader further comprises a sensor for triggering the capture of images at the appropriate time. The reader also comprises a drive mechanism for automatically presenting the paper web containing the encoded data to the imager and selectively moving and stopping the paper web at the appropriate location for imaging of the encoded data

### BRIEF DESCRIPTION OF THE DRAWINGS

The present invention will be more fully understood and appreciated by reading the following Detailed Description in conjunction with the accompanying drawings, in which:

FIG. 1 is perspective view of a reader according to the present invention.

FIG. 2 is a diagram of a paper voting record that may be tabulated by a reader according to the present invention.

FIG. 3 is block diagram of the electronic controls for a reader according to the present invention.

FIG. 4 is a flowchart of a process implemented by a reader according to the present invention.

### DETAILED DESCRIPTION OF THE INVENTION

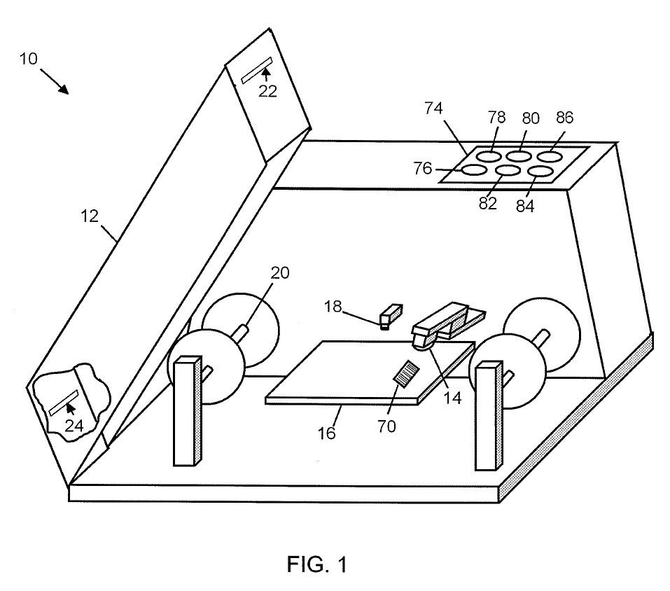

Referring now to the drawings, wherein like reference numerals refer to like parts throughout, there is seen in FIG. 1 a reader 10 according to the present invention. Reader 10 comprises a housing 12 enclosing an optical imager 14 positioned above a platen 16. A trigger sensor 18, such as a photodiode, is also positioned over one side of platen 16. Platen 16 is positioned to present a paper web to imager 14 as the web passes over platen 16.

Imager 14 generally comprises an image engine having image processing circuitry for omni-directional optical scanning. Image engine controls an image sensor, such as a complementary metal oxide semiconductor (CMOS) image sensor, and is capable of capturing two-dimensional images of 1D linear barcodes, 2D stacked/matrix barcodes, standard optical character recognition (OCR) fonts, Reduced Space Symbology (RSS) barcodes, and postal barcodes, as well as providing image captured images for use in a wide range of applications, such as image and shape recognition, signature capture, image capture, and non-standard optical character recognition. Imager 14 may further include an integrated illumination source such as one or more light emitting diodes (LEDs) of various wavelengths, to enhance illumination, operation, and image capture. For example, imager 14 may include red LEDs for general illumination and green LEDs for targeting. Imager 14 may comprise, but is not limited to, an IT4X10/80 SR/SF or IT5X10/80 series imager available from Hand Held Products, Inc. of Skaneateles Falls, N.Y. that is capable of scanning and decoding most standard barcodes including linear, stacked linear, matrix, OCR, and postal codes. Specifically, the IT5X10/80 series imager is a CMOS-based decoded output engines that can read 2D codes, and has image capture capabilities sufficient for use with reader 10.

Housing 12 further includes at least one drive roller 20, such as a take-up roller driven by a motor (not shown) for accepting the leading edge of a paper web extending from a roll and winding the web onto a second spool. In an alternative embodiment, mechanism 18 may comprise a nip roller for grasping and advancing a fan-fold paper web. In this embodiment, housing 12 may include a first slot 22 for inserting the leading edge of the paper web, and a second slot 24 positioned on the opposite side of housing 12 for feeding the paper web into a collecting region.

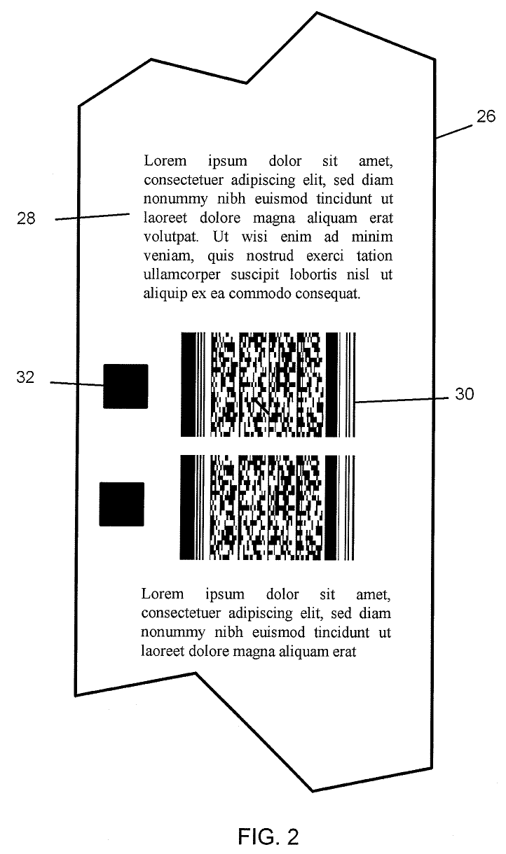

Referring to FIG. 2, a paper web 26 used in connection with reader 10 includes a header 28 having text information about a vote, such as the location where the vote was cast, the name of the candidate for whom the vote was cast, etc. Following header 28 may be one or more barcodes 30 having the voting information encoded therein. Proximate to each barcode 30 is an alignment mark 32. The header 28, barcode 30, and mark 32 are printed on paper web 26 by an electronic voting machine and stored in roll or fan fold format for future auditing by reader 10.

When the electronic voting results are ready to be audited web 26 is presented to reader 10. In the case of a rolled web 26, the roller may be positioned on an axle 34 in reader 10 and web 26 fed into drive roller 20. In an alternative embodiment, a fan fold paper web 26 may be inserted into slot 22 for engagement by drive roller 20, which could include a nip roller for automatically grasping and advancing web 26. In either case, web 26 is positioned over platen 16 such that imager 14 is aligned to capture optical images of barcodes 30, and trigger sensor 18 is aligned to detect alignment marks 32.

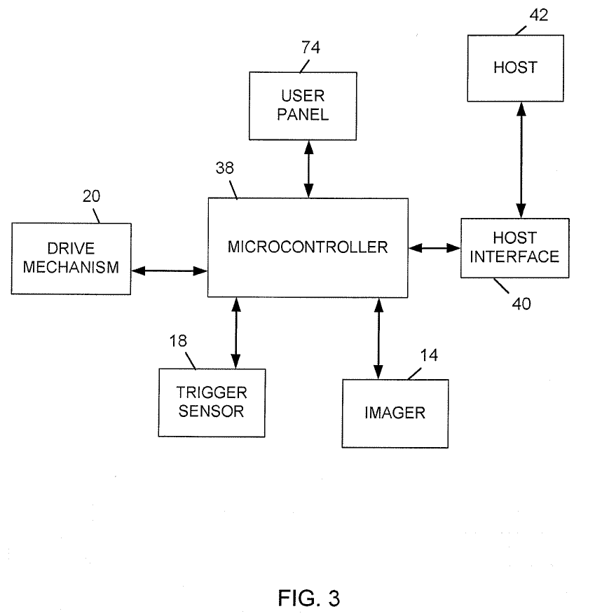

Referring to FIG. 3, electronic controls 36 for reader 10 comprise a microcontroller 38 interconnected to imager 14 and trigger sensor 18. Microcontroller 38 comprises a conventional programmable microprocessor having on-chip peripherals, such as central processing unit, Flash EEPROM, RAM (which may also be provided off-chip), asynchronous serial communications interface modules, serial peripheral interfaces, Inter-IC Buses, timer modules, pulse modulators with fault protection modules, pulse width modulators, analog-to-digital converters, and digital-to-analog converters. Additionally, the inclusion of a PLL circuit allows power consumption and performance to be adjusted to suit operational requirements. In addition to the I/O ports dedicated I/O port bits may be provided. Microcontroller 38 may further include an on-chip bandgap based voltage regulator that generates an internal digital supply voltage from an external supply range. Microcontroller 38 preferably comprises a Freescale MC9328MXS.

Microcontroller 38 is further interconnected to a host interface 40, which is in turn interconnected to a host device 42, such as a computer. Interface 40 may comprise a conventional RS232 transceiver and associated 12 pin RJ style jack or USB port. For example, an ADM202EARN available from Analog Devices, Inc. of Norwood, Mass. is a suitable RS-232/V.28 interface device having compliant levels of electromagnetic emissions and immunity. Alternatively, interface 40 may comprise other conventional buses, such as USB, IEEE 1394, or PCMCIA, or other connector styles, such as an FFC style to an embedded host. Interface 40 may also comprise a wireless transceiver for wireless communication to host device 42. Host interface 40 may also further comprise or standard USB cable. Regardless of the type of connection, host interface 40 is programmed with the applicable protocols for interfacing with a host computer, such as USB, Bluetooth(r), and IrDA protocols (if wireless capabilities are provided).

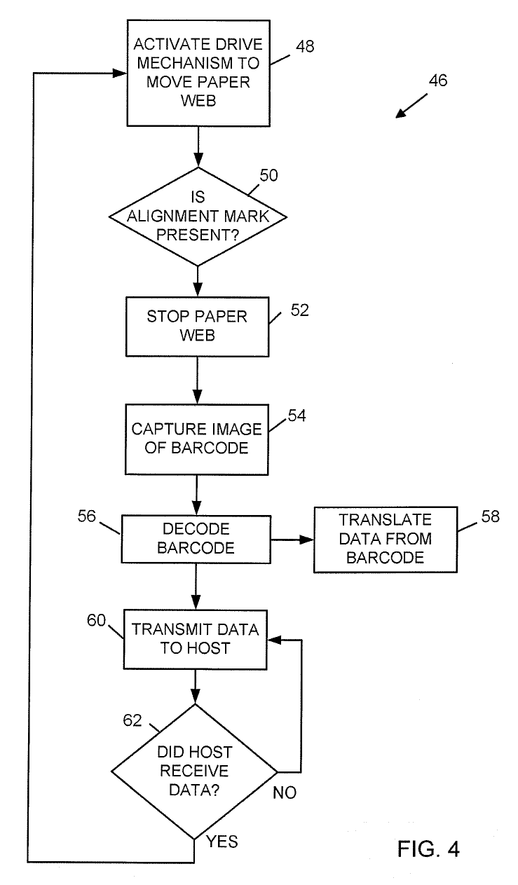

Referring to FIG. 4, microcontroller 38 of reader 10 implements an automatic auditing process 46 which begins by activating 48 drive roller 20 to move paper web 26 across platen 16. A check is then performed 50 to determine whether trigger sensor 18 has detected alignment mark 32. If so, drive roller 20 is controlled 52 to stop web 26 and imager 14 is activated 54 to capture an image of barcode 30. If imager 14 is sufficiently fast enough, the step of stopping web 26 may be omitted if an image of moving web 26 is sufficient to allow interpretation of encoded date. The data encoded in barcode 30 is then decoded 56 by imager 14 and provided to microcontroller 38. In the event that the decoding process does not determine the presence of encoded data, paper web 26 may be driven in a predetermined pattern in an attempt to locate barcode 30. For example, web 26 may be driven in a binary search pattern using the initial location of alignment mark 32 as a reference point for determining the size of the search pattern. In the event that barcode 30 is not found after a predetermined number of steps, web 26 may be driven to next alignment mark 32

When a barcode is successfully decoded, microcontroller 38 receives the decoded data and, if desired, further processes decoded data by translating the data 58 into a predetermined format or protocol. The decoded data, whether translated or not, is then transmitted 60 to host device 42 via interface 40. The decoded data may be appended with a CRC and a sequence number to allow for recognition of a missed or improperly read barcode 30. A check is then performed 62 to determine whether host device 42 has received the decoded data. For example, host device 42 may return a command or byte confirming that the decoded data has been received. Once receipt of the data has been confirmed at step 62, control returns to the beginning so that drive roller 20 may be operated to move web 26 forward or backward to the next barcode 30 and alignment mark 32.

Host device 42 may be programmed to tabulate the decoded data received from reader 10, whether from a single web 26 or multiple webs 26 presented sequentially or at different times. For example, host device 42 may include software for tabulating the voting results, storing the results in a local database, and generating auditing records that may be compared against the results tabulated by the voting machines to confirm the accuracy of the election results. In addition, host device 42 may be programmed to receive and notify the user of all anomalies, such as errors, failed decoding efforts, or security problems.

In another embodiment of the invention, platen 16 may include a stand code 70 printed thereon for control purposes. In particular, when web 26 has passed entirely across platen 16, imager 14 captures an optical image of stand code 70. Receipt of the predetermined data encoded into stand code 70 by microcontroller 38 signals that web 26 has been exhausted and automatic reading of voting information according to process 46 has been completed.

Referring to FIG. 1, reader 10 may additionally comprise a user panel 74 interconnected to microcontroller 38 for communicating device status to a user and proving for manual control of drive mechanism 20. For example, panel 74 may include light-emitting diodes (LEDs) indicating power status 76, proper reading operation 78, security status 80, and an error condition 82. For example, security status 80 may be illuminated in the event that housing 12 or any components therein are compromised, thereby notifying the user of the possibility that that reader 10 has been tampered with. Panel 74 may also include a manual operation switch 84 allowing a user to manually advance or rewind web 26 using appropriate forward and reverse buttons 86 and 88, respectively.

What is claimed is:

1. An apparatus for automatically tabulating electronic voting records, comprising:
a housing having a platen;
a drive mechanism positioned for advancing a paper web across the platen;
an optical imager aligned to capture an image of the paper web; and
a microcontroller programmed to selectively operate the drive mechanism.

2. The apparatus of claim 1, further comprising a sensor positioned proximately to said web and interconnected to said microcontroller.

3. The apparatus of claim 2, wherein said microcontroller is programmed to selectively operate the drive mechanism in response to detection of a predetermined mark printed on the paper web by said sensor.

4. The apparatus of claim 3, wherein the microcontroller is programmed to trigger said optical imager to capture an image of the paper web when said sensor detects the predetermined mark.

5. The apparatus of claim 4, further comprising a host interface interconnected to said microcontroller.

6. The apparatus of claim 5, wherein said imager decodes information encoded in the image of the paper web and provides the information to the microcontroller.

7. The apparatus of claim 6, wherein the microcontroller is programmed to transmit the decoded information through said host interface.

8. The apparatus of claim 3, wherein said microcontroller is programmed to selectively operate the drive mechanism in a predetermined search pattern if said image of said paper web does not include barcode information.

9. A method of automatically auditing an electronic voting record, comprising the steps of:
advancing the voting record;
using an optical imager to capture an image of the voting record;
decoding information encoded in the image of the voting record; and
transmitting the decoded information to a host device.

10. The method of claim 9, further comprising the step of checking for an alignment mark prior to capturing the first image of the voting record.

11. The method of claim 10, further comprising the step of stopping advancement of the voting record when an alignment mark is detected.

12. The method of claim 11, further comprising the step of checking to determine whether the host device received the transmitted information prior to advancing the voting record.

13. The method of claim 12, further comprising the step of advancing the voting record if the host device received the transmitted information

14. The method of claim 10, further comprising step of moving the voting record in a predetermined pattern if said image does not include information that may be decoded.
